(19) United States
(12) Patent Application Publication
(10) Pub. No.: US 2024/0167499 A1
(43) Pub. Date: May 23, 2024

(54) LASER MARKED FASTENERS

(71) Applicant: MACLEAN-FOGG COMPANY, Mundelein, IL (US)

(72) Inventors: Joe CURTIN, Mundelein, IL (US); Mark RAVES, Mundelein, IL (US); Luke Michael ROBERTS, Madison Heights, MI (US); Joseph VERLA, Bloomfield Hills, MI (US); Kenneth James RIMATZKI, Harrison Township, MI (US)

(73) Assignee: MACLEAN-FOGG COMPANY, Mundelein, IL (US)

(21) Appl. No.: 18/280,233

(22) PCT Filed: Mar. 2, 2022
(86) PCT No.: PCT/US2022/018550

§ 371 Date: Sep. 3, 2023

Related U.S. Application Data
(60) Provisional application No. 63/155,576, filed on Mar. 2, 2021.
(60) Provisional application No. 63/155,565, filed on Mar. 2, 2021.

(51) Int. Cl. F16B 37/14; B23K 26/352; B23K 26/362; F16B 23/00; B23K 103/04

(52) U.S. Cl. CPC F16B 37/14; B23K 26/3584; B23K 26/362; F16B 23/00; B23K 2103/05; F16B 2200/95

(57) ABSTRACT

The fastener assembly includes a fastener body having a threaded portion at a lower end, and a stem portion at an upper end. A cap has side walls defining a wrenching surface and a top surface connecting the top surface where the cap is secure to the stem portion on the upper end of the fastener body. The assembly also includes a decorative laser mark defined on the top surface of the cap.

### CROSS-REFERENCE TO RELATED APPLICATIONS

This application claims the benefit of U.S. provisional application Ser. No. 63/155,576 filed Mar. 2, 2021, and U.S. provisional application Ser. No. 63/155,565 filed Mar. 2, 2021, the disclosures of which are hereby incorporated in their entirety by reference herein.

### BACKGROUND

The present invention relates generally to fasteners and more particularly to decorative wheel fasteners.

### SUMMARY

According to at least one embodiment, the fastener assembly includes a fastener body having a threaded portion at a lower end, and a stem portion at an upper end. The assembly also includes a cap having side walls defining a wrenching surface and a top surface connecting the top surface where the cap is secure to the stem portion on the upper end of the fastener body. The assembly also includes a decorative laser mark defined on the top surface of the cap.

In another embodiment, the decorative laser mark has a white color.

In another embodiment, the decorative laser mark has an L-value being at least 70. The white color of the decorative laser mark has an a-value less than 5 and a b-value less than 9.5.

In another embodiment, the cap is formed of stainless-steel material.

In another embodiment, the decorative laser mark has a surface finish being a diffuse surface. In another embodiment, the diffuse surface has a surface roughness being greater than the surface finish of the cap.

In another embodiment, the decorative laser mark has a color being at least one of black, red, green, yellow or blue or a combination thereof.

In another embodiment, the decorative laser mark has line spacing less than 0.7 mm.

In another embodiment, the fastener body has a friction-controlled coating.

According to one embodiment, a method of forming a fastener is provided. The method also includes forming a cap having a plurality of wrenching surfaces and a top surface. The method also includes laser marking a decorative mark on the top surface. The method also includes forming a fastener body having a threaded portion adjacent a first end and a stem adjacent a second end. The method also includes securing the cap to the stem after laser marking the top surface.

In another embodiment, the method may include coating the cap with a clear protective coating after laser marking.

In another embodiment, the cap is secured to the stem by crimping.

In another embodiment, the laser marking may include laser etching to form a white laser mark. The laser marking may include laser annealing to form a colored laser mark.

In another embodiment, the method may include applying a friction-controlled coating to the fastener body before securing the cap.

### BRIEF DESCRIPTION OF THE DRAWINGS

FIG. 1 illustrates a perspective view of a cap having a laser etched decorative mark according to one embodiment.

FIG. 2 illustrates a perspective view of a cap having a laser etched decorative mark according to another embodiment.

FIG. 3 illustrates the laser etching process for applying a decorative mark and showing the angle of incidence.

FIG. 4 shows the laser parameters and the resulting laser marking properties.

FIGS. 5-6 show laser etched fasteners based on various parameters.

FIG. 7 illustrates a perspective view of a cap having a laser annealed decorative mark according to one embodiment.

FIG. 8 illustrates a perspective view of a cap having a laser annealed decorative mark on the cap according to another embodiment.

FIG. 9 is a flow chart illustrating a method of forming a fastener assembly.

FIG. 10 illustrates a side/section view of a fastener according to one embodiment.

FIG. 11 illustrates a side/section view of a fastener according to another embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The Figures show a variety of fasteners having different laser marks. Laser marking occurs when the laser beam interacts with the surface of a material, slightly altering its properties or appearance. The laser marking process may used to add logos, images, text, or other marks to fasteners.

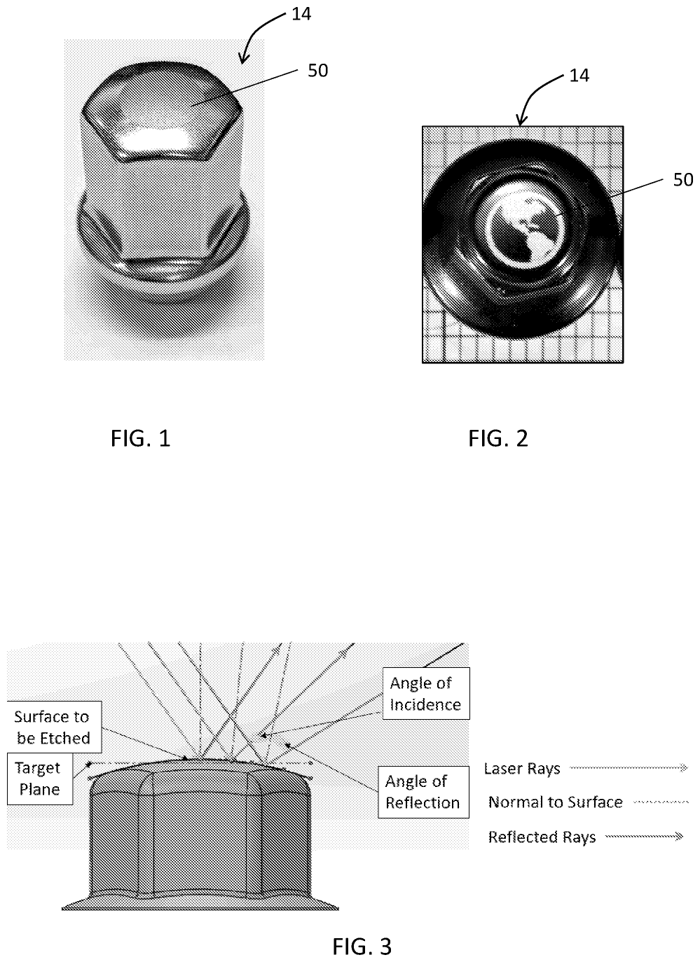

FIGS. 1-2 illustrate a cap 14 with a laser etched decorative mark. FIG. 1 shows a perspective view of a cap 14 having a laser etched decorative mark 50 formed on a bare surface of a stainless-steel cap. FIG. 2 shows a top perspective view of a cap 14 having a laser etched decorative mark 50 formed on a cap with a black surface coating. Laser etching may be done on anodized or plated metal surfaces. Laser etching may be used with various materials including steel, stainless steel, tungsten, titanium, aluminum, anodized aluminum black oxide or chrome, lead, magnesium zinc or other materials.

Laser etching occurs when energy is transferred from a laser beam to the target surface, causing the surface particles to be rapidly excited. When the laser beam contacts the surface, the energy levels of the surface particles increase, increasing the temperature. Energy, in the form of heat, is then transferred from the excited particles to adjacent lower energy particles. The energy transferred increases the temperature of the target surface to the materials sublimation (boiling) point. As the material is vaporized, the surrounding material cools rapidly, causing localized surface roughness changes, creating the decorative mark. Laser etching may include a process where the laser beam physically removes the surfaces of the material. Laser etching may remove 0.001″ or less of the material.

Laser etching changes the surface finish of metals, it alters its reflectivity and enhances contrast. The laser etching creates a surface roughness that causes light to be reflected at different angles creating a diffuse reflection. The diffuse reflection at the laser marked area makes the surface appear white. For example, the surface roughness (Ra) of the decorative mark 50 may be 39-75μin. The surface roughness of the decorative mark 50 may be different than the roughness of the top surface of the cap 14 where the cap 14 may have a generally more reflective surface finish.

Laser marking may be performed using YAG lasers and MOPA (Master Oscillator Power Amplifier) lasers. The laser may also be a fiber laser. The shade of the etched mark can be manipulated by controlling differences in laser properties and parameters including pulse frequencies, power, speed, focal distance, line spacing or other laser properties. Fasteners marked with the laser etching process do not need additional protection from corrosion. The laser etched samples do not have corrosion even after a salt bath durability test. The laser etched markings may be different designs to include logos, font or other images.

The laser parameters and properties are varied to ensure an aesthetically acceptable laser mark that also passes the corrosion and durability requirements of wheel fasteners, such as salt spray testing.

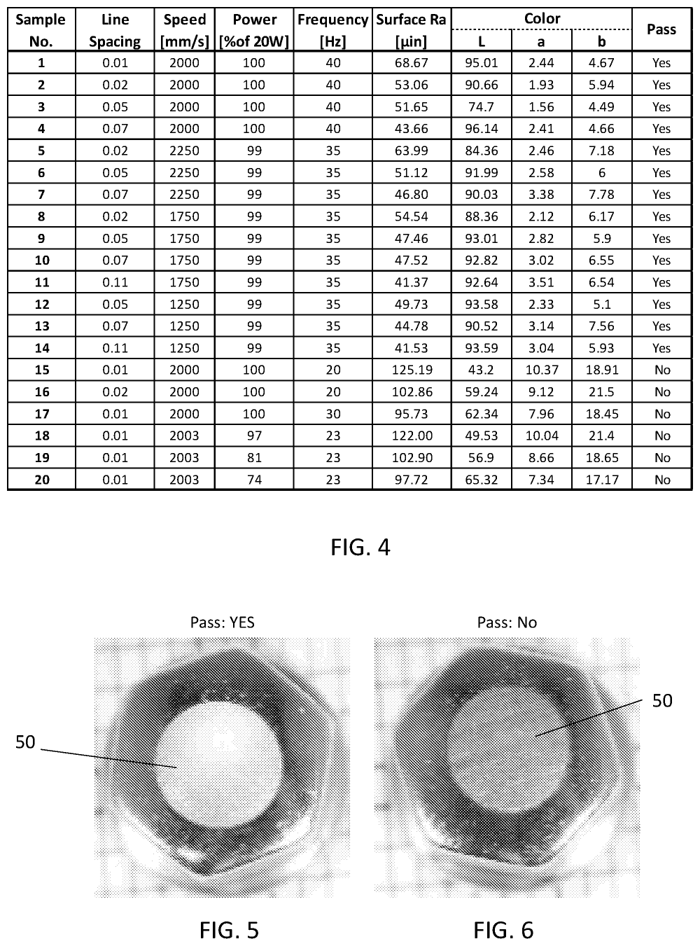

The table in FIG. 4 shows laser parameters of line spacing, linear speed, power (as a percentage of 20W) and pulse frequency and the respective outputs after one (1) crosshatched pass. The outputs include the surface finish (Ra), and resulting color values (L, a, b) that are indicators that the etch is acceptable to meet durability requirements for corrosion resistance.

The 3-dimensional color space is built-up from three axes that are perpendicular to one another. The L-axis gives the lightness: a white object has an L-value of 100 and the L-value of a black object is 0. Chromatic colors are described by using the two axes in the horizontal plane. The a-axis is the green-red axis and the b-axis goes from blue (−b) to yellow (+b). Each color is represented by a color point L, a and b color coordinates (L, a, b). As shown in FIGS. 1-2, the laser etched marking according to the present application appears white or frosted. As such, the resulting mark may have color where L is greater than approximately 70. The resulting mark may also be controlled to have an a-value color less than 4.5. The b-color value may be controlled to be generally less than 9.5. In another embodiment, the L-value may be greater than 72 and the a-value less than 4.3 and the b-value less than 9.2. However, other combinations of color values may be acceptable and the level of discoloration that is acceptable.

FIGS. 5-6 show laser etched fasteners based on various parameters. FIG. 5 illustrates a cap with a decorative laser mark 50 with an acceptable color. For example, the cap in FIG. 5 may correspond to samples 1-14 in FIG. 4 having acceptable L, a, b values. The decorative mark 50 in FIG. 5 appears white or frosted. In contrast, FIG. 6 illustrates a cap with a decorative laser mark 50 with unacceptable color where the laser mark appears dark brown or orange and may correspond to a representative sample 15-20 in FIG. 4.

Another laser parameter may be the angle of incidence. FIG. 3 illustrates the concept of the angle of incidence and reflection. These angles are equal and evenly divided by the plane normal to the etching surface at the point of contact. The greater the angle of incidence the more energy is reflected from the surface and not absorbed. The top surface of the cap 14 may not be completely flat and typically has a rounded or pointed surface. It was found that limiting the angle of incidence, color of the laser etched mark is consistent, even if the top surface of the cap is not flat. For example, the angle of incidence may be limited to less than 30-degrees. Other angles of incidence may be acceptable depending on a shape of the top surface.

Laser etching does not change the material composition of the cap and only removes some material in the area of the laser mark. Therefore, a stainless-steel cap having a laser etched mark would not need additional protective coating. Another advantage of laser etching is that laser etching is a fast laser marking process. For example, laser etching may be twice as fast as laser anneal marking. To increase the etching speed, higher laser powers may be used. Further, laser etching white marks may be faster than laser etching black marks.

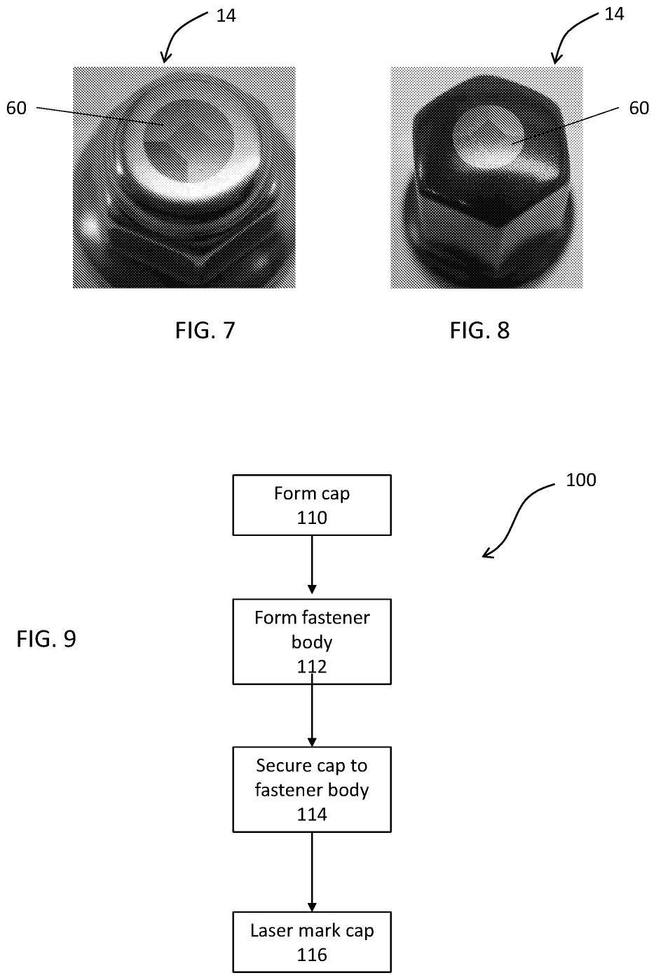

FIGS. 7-8 illustrate fasteners having laser annealed decorative markings 60 according to another embodiment. The color laser marking is essentially an annealing process. FIG. 7 shows a perspective view of a cap 14 having a laser annealed decorative mark 60 formed on a bare surface of a stainless-steel cap.

FIG. 8 shows a top perspective view of a cap 14 having a laser annealed decorative mark 60 formed on a cap with a black surface coating. Laser annealing may be done on anodized or plated metal surfaces. Laser annealing may be used with various materials including steel, stainless steel, tungsten, titanium, aluminum, anodized aluminum black oxide or chrome, lead, magnesium zinc or other materials.

In marking with laser annealing, the surface of the material remains intact. Laser annealing occurs when the laser beam interacts with the surface of a material, slightly altering its properties or appearance. In laser annealing, a low-powered laser beam is moved slowly across a fastener surface. The laser beam heats the surface material of the fastener, causing oxidation under the surface and turning the material. The laser beam applies low temperatures to metal to anneal the surface. This creates high-contrast marks without disrupting the material and leaving the surface intact.

The Laser annealing marks may be created using YAG lasers and MOPA (Master Oscillator Power Amplifier) lasers. The laser may also be a fiber laser. Different colors can be produced by manipulating laser properties and parameters including differences in power, speed, frequency, angle, or other laser properties. Further, the mark clarity/darkness, and the process output ability to resist corrosion, may be a function of laser output power in combination with the marking time.

Although the laser annealing marking does not remove material, laser annealing causes carbon to migrate to the surface of the fastener to create different colors. Control of the laser parameters allows control of the discoloration. Laser annealing may be required for L-values less than 70 and a-values greater than 4.5 and b-values greater than 9.5 where colors other than white are desired.

The heat used during the process, such as during coloration, can damage the passive layer on the marked surface. For example, corrosion-resistant materials such as stainless steel have a natural corrosion-resistant layer consisting of chromium oxide. The annealing process changes may change the chemical composition and the laser mark may be susceptible to corrosion. The cap 14 may be treated or coated after laser marking to reduce subsequent corrosion and maintain the corrosion resistance of the fastener. There are several ways to reduce corrosion on marked surfaces such as applying a clear protective coating to the marked surface or re-passivating in citric acid or nitric acid. For example, an acrylic urethane coating such as Plexon may be applied after the laser annealed marking. The protective coating may be applied to the entire cap, or just the top surface. In other embodiment, because the laser annealed mark does not change the surface roughness or surface finish, a secondary coating may not be required.

Other suitable fastener materials may be laser marked including steel, stainless steel, tungsten, titanium, aluminum, black oxide or chrome, or other materials.

FIGS. 10-11 illustrate the side/section view of capped wheel fasteners. FIG. 10 illustrates the wheel fastener assembly 10 that is a wheel nut having a fastener body 12 and a cap 14. The fastener body 12 has a threaded portion 16, which in this embodiment is defined as an internal thread. Similarly, FIG. 11 illustrates a wheel fastener that is a bolt having a threaded portion 16 with an external thread.

The fastener body has a longitudinal axis A and the threaded portion 16 is centered about the longitudinal axis. The threaded portion 16 is located adjacent a lower end of the fastener body 12. A stem portion 20 is located at an upper end of the fastener body 12. The stem portion 20 provides a mounting location for mounting the cap. As illustrated, the stem portion 20 may define a wrenching surface 18 oriented generally parallel to the longitudinal axis A. The wrenching surface 18 can be hexagonal in shape and, as shown, the wrenching surface defines a set of six wrench flats designed to accept torque from a tool such a lug-wrench. The stem portion 20 may also have other configurations with different wrenching surfaces or different shape to engage the cap 14. For example, the stem portion 20 may have a shape that allows the cap to spin freely for a decorative security feature such as cylindrical shaped or portions that are tangential to the cap 14.

The fastener body 12 has a flange 22 that extends radially outwardly from the stem portion 20. The cap 14 is shaped generally to conform to the stem portion 20 and may also conform to at least a portion of the flange 22. Thus, the cap 14 also defines an outer wrenching surface 26 arranged in a hexagonal pattern, as shown in FIG. 1. Other suitable wrenching surfaces may be used. In one example, the fastener may have a three-point wrenching surface, a hybrid three-point wrenching surface, a keyed wrenching surface, or other wrenching surface

The cap 14 also defines the top surface 30 of the fastener 10. The top surface 30 is opposite the threaded portion 16 and defines the outer surface of the fastener 10 when the fastener is installed in the wheel. The top surface 30 may include the laser etching 40, as illustrated in the Figures.

For example, the fastener 10 may have a top surface 30 shaped as a round dome, a flat dome, cone, or a pointed dome. The top surfaces may also include other suitable shapes for laser etchings.

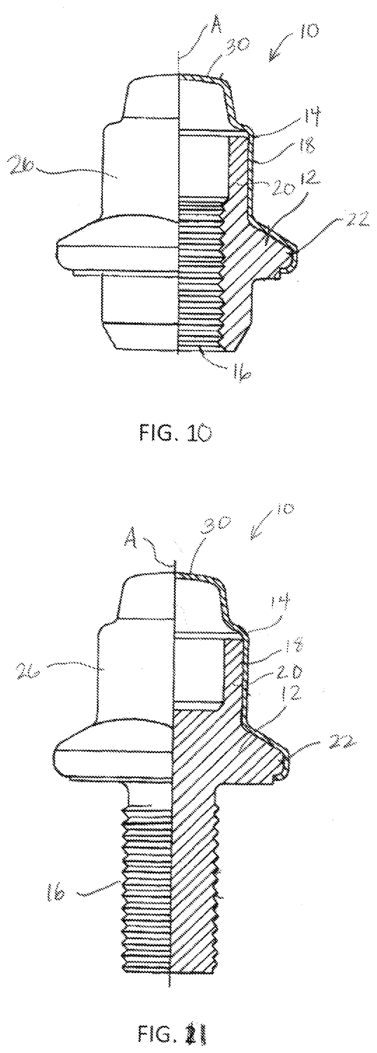

FIG. 9 illustrates a flow chart illustrating the method 100 of forming the laser marked fasteners. In step 110, the cap 14 is formed. The cap 14 may be made of a sheet metal such as stainless steel, such as 304SS or 436SS. The cap 14 may also be formed of other suitable materials. The cap 14 may also be performed on coated, anodized or plated metal surfaces. The cap 14 may have a black coating, such as a black oxide coating, or a black chrome coating. In another embodiment, the fastener may have a thin-film coating or physical vapor deposition (PVD) coating. In the examples with a black coating, the laser etching process may form a bump or groove only in the coating, and not in the underlying fastener or cap surface.

In step 112, the fastener body 12 is formed. The fastener body 12 may be cold formed of a metal such as a low or medium carbon steel. Forming the cap separate from the fastener body 12 allows the use of all types of coating, plating and coating or plating alone on the fastener body 12. Therefore, the cap 14 may be a stainless steel that provides durability and desirable appearance without using chrome which provides durability and avoids rust and other issues associated with chrome. The fastener body 12 may have a friction-controlled coating to ensure clamp-load.

In step 114, the cap 14 is secured to the fastener body 12. The cap 14 may be crimped or secured on the fastener body 12 so that forces exerted on the wrenching surface 18 cannot act to dislodge the cap 14. The cap 14 may be secured on the fastener body 12 without any welding attachment or any adhesive attachment between the cap 14 and the body 12.

In step 116, the cap is laser marked. The cap may be laser marked with a white/frosted mark or a color laser mark, as discussed above. The laser marking parameters were developed to ensure the thin cap is not damaged and ensures durability while still obtaining a clear mark.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A fastener assembly comprising:
a fastener body having a threaded portion at a lower end, and a stem portion at an upper end;
a cap having side walls defining a wrenching surface and a top surface connecting the top surface wherein the cap is secure to the stem portion on the upper end of the fastener body; and
a decorative laser mark defined on the top surface of the cap.

2. The fastener assembly according to claim 1, wherein the decorative laser mark has a white color.

3. The fastener assembly according to claim 2, wherein the decorative laser mark has an L-value being at least 70.

4. The fastener assembly according to claim 2, wherein the white color of the decorative laser mark has an a-value less than 4.5 and a b-value less than 9.5.

5. The fastener assembly according to claim 1, wherein the cap is formed of stainless-steel material.

6. The fastener assembly according to claim 1, wherein the decorative laser mark has a surface finish being a diffuse surface.

7. The fastener assembly according to claim 6, wherein the diffuse surface has a surface roughness being greater than a surface finish of the cap.

8. The fastener assembly according to claim 7, wherein surface roughness Ra is in the range of 39 to 75 μin.

9. The fastener assembly according to claim 1, wherein the decorative laser mark has a color being at least one of black, red, green, yellow or blue or a combination thereof.

10. The fastener assembly according to claim 1, wherein the cap has a coating over the decorative laser mark.

11. The fastener assembly according to claim 1, wherein the decorative laser mark has line spacing less than 0.7 mm.

12. The fastener assembly according to claim 1, wherein the fastener body has a friction-controlled coating.

13. A method of forming a fastener, comprising:
forming a cap having a plurality of wrenching surfaces and a top surface;
laser marking a decorative mark on the top surface;
forming a fastener body having a threaded portion adjacent a first end and a stem adjacent a second end; and
securing the cap to the stem after laser marking the top surface.

14. The method of claim 13, further comprising coating the cap with a clear protective coating after laser marking.

15. The method of claim 13, wherein the cap is secured to the stem by crimping.

16. The method of claim 13, wherein the cap is formed of stainless steel.

17. The method of claim 13, wherein the laser marking comprises laser etching to form a white laser mark.

18. The method of claim 13, wherein the laser marking comprises laser annealing to form a colored laser mark.

19. The method of claim 18, further comprising applying a clear coating to the cap after laser annealing the colored laser mark.

20. The method of claim 13, further comprising applying a friction-controlled coating to the fastener body before securing the cap.
